(19) United States
(12) Patent Application Publication
(10) Pub. No.: US 2025/0187873 A1
(43) Pub. Date: Jun. 12, 2025

(54) APPARATUS FOR PLANNING MAINTENANCE FOR AN ELEVATOR

(71) Applicant: CEDES AG, Landquart (CH)

(72) Inventors: Michele GUIDOTTI, Giubiasco (CH); Klims SAIKINS, Chur (CH); Martin HARDEGGER, Sargans (CH)

(73) Assignee: CEDES AG, Landquart (CH)

(21) Appl. No.: 18/967,827

(22) Filed: Dec. 4, 2024

(30) Foreign Application Priority Data
Dec. 11, 2023 (EP) 23 215 577.0

(51) Int. Cl. B66B 5/00; B66B 1/34

(52) U.S. Cl. CPC B66B 5/0025; B66B 1/3461; B66B 5/0037

(57) ABSTRACT

Apparatus for planning maintenance for an elevator having an elevator car having a car door having an accelerometer for detecting the vibration of the car door, having a collecting device that is designed to use the detection to create a vibration profile, having a transmission device for relaying the vibration profile to a server, and having a server for analyzing the vibration profile. The collecting device is connected to the elevator car to determine the deviation of the vibration profile from a reference profile and to take the deviation from at least one threshold or at least one value range as a basis for causing the transmission device to relay the deviation and/or the vibration profile to the server. The server is physically separate from the elevator and is designed to compare the deviation and/or the vibration profile with at least one threshold or at least one value range.

This application claims the benefit under 35 USC § 119(a)-(d) of European Application No. 23 215 577.0 filed Dec. 11, 2023, the entirety of which is incorporated herein by reference.

### FIELD OF THE INVENTION

The present invention relates to an assembly having an apparatus for planning maintenance, having an elevator, an elevator car and a car door.

### SUMMARY OF THE INVENTION

The object of the present invention is to provide an apparatus for planning maintenance for an elevator.

The assembly according to the present invention comprises an apparatus for planning maintenance for an elevator having an elevator car having a car door having an accelerometer for detecting the vibration of the car door, having a collecting device that is designed to use the detection to create a vibration profile, having a transmission device for relaying the vibration profile to a server, and having a server for analyzing the vibration profile, wherein the collecting device is physically connectable, in particular connected, to the elevator car and is designed to determine the deviation of the vibration profile from a reference profile and to take the deviation from at least one threshold or at least one value range as a basis for causing the transmission device to relay the deviation and/or the vibration profile to the server, and wherein the server is physically separate from the elevator and is designed to compare the deviation and/or the vibration profile with at least one threshold or at least one value range and to take the comparison as a basis for outputting a signal that indicates whether no action or whether an action as part of the next regular maintenance or whether an action before the next regular maintenance is supposed to take place.

The apparatus can afford the advantage that the availability of the elevator is increased. The apparatus can afford the advantage that the intervals between regular maintenance can be reduced. The apparatus can afford the advantage that the safety of persons in the elevator is increased. The apparatus can afford the advantage that less computing power needs to be implemented on the elevator car than in the server for operating the apparatus.

The collecting device can have a memory in order to store the measurement data and the vibration profile. The collecting device can have a microprocessor in order to create the vibration profile from the measurement data.

The measurement data can be oscillation amplitudes or frequencies. The vibration profile can represent oscillation amplitudes or frequencies as a function of time or a route.

The at least one threshold can be one or two or three or more numerical values. The at least one threshold can be a reference profile that extends, in particular, essentially over the same period or length of the vibration profile.

A value range can be defined by a lower and an upper threshold.

The signal can be an entry into a database. The signal can be information to a static or mobile reproduction unit. The signal can be sent wirelessly and/or using an Internet protocol.

According to the present invention, the transmission device is physically connected to the elevator car. Preferably, the transmission device and the collecting device have a common housing that is physically connected to the elevator car.

According to the present invention, the transmission device is designed to relay the deviation and/or the vibration profile to the server wirelessly and/or using an Internet protocol.

This can afford the advantage that a remote service company can be informed. This can afford the advantage that a service engineer can be informed on their mobile device via the Internet.

Preferably, the server performs the comparison of the vibration profile with the at least one threshold or the at least one value range by virtue of the amplitude of the vibration exceeding a threshold.

Preferably, the server performs the comparison of the vibration profile with the at least one threshold or at least one value range by virtue of the amplitude of the vibration periodically exceeding a threshold.

Preferably, the server performs the comparison of the vibration profile with the at least one threshold or at least one value range by virtue of a specific frequency, in particular, the natural frequency of the door, being detected.

Preferably, the server performs the comparison of the vibration profile with the at least one threshold or at least one value range by virtue of a frequency analysis and/or a wavelet analysis being performed.

Preferably, the server performs the comparison of the vibration profile with the at least one threshold or at least one value range by virtue of a frequency analysis with a pattern recognition being performed.

Further features of the invention are indicated in the drawings.

The advantages mentioned in each case can also be attained for combinations of features in connection with which they are not mentioned.

### BRIEF DESCRIPTION OF THE DRAWINGS

Exemplary embodiments of the present invention are shown in the drawings and are explained in more detail hereinbelow. Identical reference signs in the individual figures denote elements that correspond to one another.

FIG. 1 shows a flowchart for the apparatus.

### DETAILED DESCRIPTION OF THE INVENTION

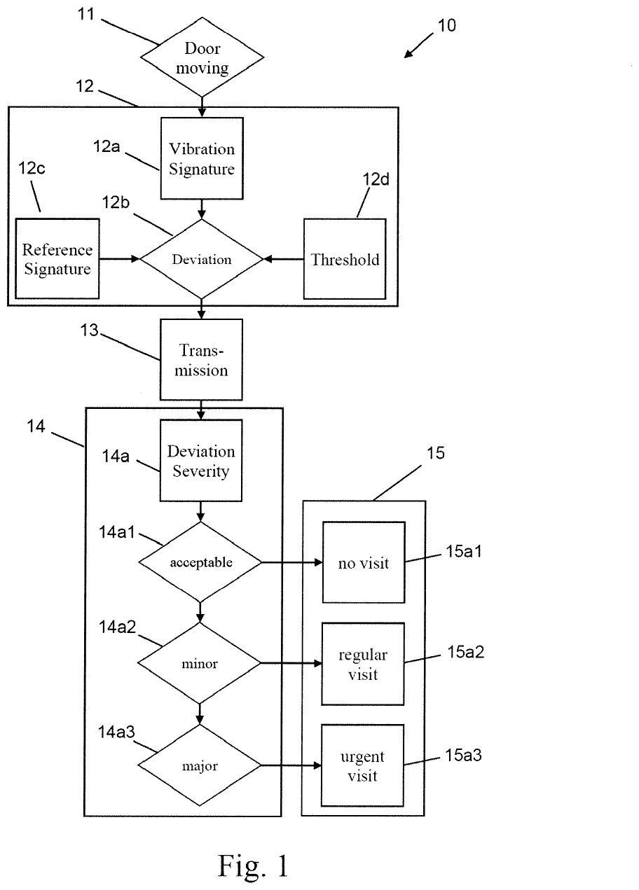

FIG. 1 shows a flowchart for the apparatus 10. The sequence starts at the accelerometer 11. The accelerometer is physically connected to, that is to say mounted on, the elevator car.

The accelerometer 11 measures the vibration of the car door during the opening and closing process and forwards the measurement to the collecting device 12. The collecting device 12 is mounted on the elevator car and, in a first step 12a, uses the measured values to obtain a vibration profile and, in a second step 12b, determines the deviation of the vibration profile from a reference profile 12c and then takes the deviation from at least one threshold as a basis for causing the transmission device 13 to relay the deviation and/or the vibration profile to the server 14. The collecting device 12 and the transmission device 13 are physically connected to, that is to say mounted on, the elevator car.

The server 14 is not physically connected to the elevator car or the elevator. It may be located in a different town than the elevator. The server 14 compares the vibration profile with at least one threshold or at least one value range and then takes the comparison 14a1, 14a2, 14a3 as a basis for outputting a signal 15 that indicates whether no action 15a1 or whether an action as part of the next regular maintenance 15a2 or whether an action before the next regular maintenance 15a3 is supposed to take place.

### LIST OF REFERENCE SIGNS

10 flowchart for the apparatus
11 accelerometer
12 collecting device
12a obtainment of vibration profile
12b deviation comparison
12c reference signature
12d threshold
13 transmission device
14 server
14a comparison whether no action
14b comparison whether action during regular maintenance
14c comparison whether action before regular maintenance
15 signal
15a1 signal for no action necessary
15a2 signal for action during regular maintenance
15a3 signal for action before regular maintenance

1-7. (canceled)

8. An assembly having an apparatus for planning maintenance for an elevator having an elevator car having a car door and having an elevator having an elevator car having a car door having an accelerometer for detecting the vibration of the car door, having a collecting device that is designed to use the detection to create a vibration profile, having a transmission device for relaying the vibration profile to a server, and having a server for analyzing the vibration profile,
wherein the collecting device is physically connectable, in particular connected, to the elevator car and is designed to determine the deviation of the vibration profile from a reference profile and to take the deviation from at least one threshold as a basis for causing the transmission device to relay the deviation and/or the vibration profile to the server, and
wherein the server is provided in a manner physically separate, in particular is physically separate, from the elevator and is designed to compare the deviation and/or the vibration profile with at least one threshold or at least one value range and to take the comparison as a basis for outputting a signal that indicates whether no action or whether an action as part of the next regular maintenance or whether an action before the next regular maintenance is supposed to take place,
wherein the transmission device is physically connected to the elevator car and the transmission device is designed to relay the deviation and/or the vibration profile to the server wirelessly and/or using an Internet protocol.

9. The apparatus according to claim 8, wherein the transmission device and the collecting device have a common housing that is physically connected to the elevator car.

10. The assembly according to claim 8, wherein the server performs the comparison of the vibration profile with the at least one threshold or at least one value range by virtue of the amplitude of the vibration exceeding a threshold.

11. The assembly according to claim 8, wherein the server performs the comparison of the vibration profile with the at least one threshold or at least one value range by virtue of the amplitude of the vibration periodically exceeding a threshold.

12. The assembly according to claim 8, wherein the server performs the comparison of the vibration profile with the at least one threshold or at least one value range by virtue of a specific frequency, in particular the natural frequency of the door, being detected.

13. The assembly according to claim 8, wherein the server performs the comparison of the vibration profile with the at least one threshold or at least one value range by virtue of a frequency analysis and/or a wavelet analysis being performed.

14. The assembly according to claim 8, wherein the server performs the comparison of the vibration profile with the at least one threshold or at least one value range by virtue of a frequency analysis with a pattern recognition being performed.
